(19) United States
(12) Patent Application Publication
(10) Pub. No.: US 2025/0308083 A1
(43) Pub. Date: Oct. 2, 2025

(54) REFERENCE IMAGE STRUCTURE MATCH USING DIFFUSION MODELS

(71) Applicant: ADOBE INC., SAN JOSE, CA (US)

(72) Inventors: Sachin Madhav Kelkar, Santa Clara, CA (US); Fengbin Chen, Los Gatos, CA (US); Hareesh Ravi, San Jose, CA (US); Zhifei Zhang, San Jose, CA (US); Ajinkya Gorakhnath Kale, San Jose, CA (US); Zhe Lin, Clyde Hill, WA (US)

(21) Appl. No.: 18/947,959

(22) Filed: Nov. 14, 2024

Related U.S. Application Data
(60) Provisional application No. 63/569,890, filed on Mar. 26, 2024.

(51) Int. Cl. G06T 11/00

(52) U.S. Cl. CPC G06T 11/00

(57) ABSTRACT

A method, apparatus, non-transitory computer readable medium, and system for image processing include obtaining a structural input indicating a target spatial structure, encoding, using a condition encoder, the structural input to obtain a structural encoding representing the target spatial structure, and generating, using an image generation model, a synthetic image based on the structural encoding, where the synthetic image depicts an object having the target spatial structure.

### CROSS-REFERENCE TO RELATED APPLICATION

This application claims priority under 35 U.S.C. § 119 to U.S. Provisional Application No. 63/569,890, filed on Mar. 26, 2024, in the United States Patent and Trademark Office, the disclosure of which is incorporated by reference herein in its entirety.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on a conditioning.

In the field of image generation, an input image and a text prompt are provided to a machine learning model to generate a synthetic image that includes an image structure as depicted in the input image. In some cases, the input image includes an image element that depicts a structural input. In some cases, the text prompt describes an image element to be generated having the structural input. However, in some cases, extensive training in an image generation model may be needed to perform the structure matching task.

### SUMMARY

Aspects of the present disclosure provide a method and system for image generation. In one aspect, the system receives an input image depicting a spatial structure and a text prompt describing an image element, and generates a synthetic image depicting the image element having the spatial structure. According to some aspects, the system includes a condition encoder configured to generate a structural encoding that represents the input spatial structure. In some aspects, the system includes an image generation model trained to generate an output feature by combining the structure encoding and the intermediate feature generated in each encoding layer of the U-Net of the image generation model. In some cases, the system decodes the output feature to generate the synthetic image. By combining the structural encoding with the intermediate feature at each encoding layer, the image generation model ensures that the synthetic image accurately depicts the target spatial structure from the input image and the image element described by the text prompt.

A method, apparatus, non-transitory computer readable medium, and system for image processing include obtaining a structural input indicating a target spatial structure, encoding, using a condition encoder, the structural input to obtain a structural encoding representing the target spatial structure, and generating, using an image generation model, a synthetic image based on the structural encoding, where the synthetic image depicts an object having the target spatial structure.

A method, apparatus, non-transitory computer readable medium, and system for training a machine learning model include obtaining a training set comprising a training structural input indicating a spatial structure and a ground-truth image including the spatial structure, and training, using the training set, an image generation model to generate a synthetic image based on a structural input, where the synthetic image includes the spatial structure.

An apparatus and system for image processing include a memory component, and a processing device coupled to the memory component, the processing device is configured to perform operations comprising: obtaining a structural input indicating a target spatial structure, encoding, using a condition encoder, the structural input to obtain a structural encoding representing the target spatial structure, and generating, using an image generation model, a synthetic image based on the structural encoding, where the synthetic image depicts an object having the target spatial structure.

### BRIEF DESCRIPTION OF THE DRAWINGS

FIG. 1 shows an example of an image processing system according to aspects of the present disclosure.

FIG. 2 shows an example of a method for generating a synthetic image according to aspects of the present disclosure.

FIG. 3 shows an example of image generation based on a depth conditioning according to aspects of the present disclosure.

FIG. 4 shows an example of image generation based on an edge conditioning according to aspects of the present disclosure.

FIG. 5 shows an example of image generation based on various levels of structure adherence according to aspects of the present disclosure.

FIG. 6 shows an example of a method for image processing according to aspects of the present disclosure.

FIG. 7 shows an example of an image processing apparatus according to aspects of the present disclosure.

FIG. 8 shows an example of a machine learning model according to aspects of the present disclosure.

FIG. 9 shows an example of image generation based on a reference image according to aspects of the present disclosure.

FIG. 10 shows an example of image generation based on entity control according to aspects of the present disclosure.

FIG. 11 shows an example of image generation based on user sketch according to aspects of the present disclosure.

FIG. 12 shows an example of an image generation model according to aspects of the present disclosure.

FIG. 13 shows an example of a U-Net according to aspects of the present disclosure.

FIG. 14 shows an example of a diffusion process according to aspects of the present disclosure.

FIG. 15 shows an example of a method for generating a synthetic image using a structural encoder according to aspects of the present disclosure.

FIG. 16 shows an example of a method for training a machine learning model according to aspects of the present disclosure.

FIG. 17 shows an example of figure description according to aspects of the present disclosure.

FIG. 18 shows an example of a flow diagram depicting an algorithm as a step-by-step procedure in an example implementation of operations performable for training a machine learning model according to aspects of the present disclosure.

FIG. 19 shows an example of a method for training a diffusion model according to aspects of the present disclosure.

FIG. 20 shows an example of a computing device according to aspects of the present disclosure.

### DETAILED DESCRIPTION

Aspects of the disclosure relate to image generation using generative machine learning. Embodiments of the disclosure relate to an image generation system that accurately generates images that depict an object described by a text prompt and having a spatial structure from an input image. In some aspects, the system includes a condition encoder trained to generate structural encoding based on the input image, and an image generation model trained to generate the synthetic image based on the structural encoding. The structural encoding generated by the condition encoder is provided to the encoding layers of the image generation model to ensure that a target structural encoding from the input image is maintained in or transferred to the synthetic image.

Some conventional image generation models, such as ControlNet, include multiple convolutional layers, self-attention layers, and cross-attention layers. Due to the architectural complexity, conventional methods are unable to train the entire image generation model (including U-Net, convolutional layer, self-attention layer, and cross-attention layer). In some cases, the U-Net might not be trained. As a result, the conventional image generation model requires a longer processing time to generate an output image. In some cases, the output image might not depict the conditioning input due to the lack of training.

Accordingly, embodiments of the disclosure provide a system and a method that improve on conventional image generation systems by accurately generating a synthetic image that depicts an object described by a text prompt and having a spatial structure from an input image. This is achieved using a system that includes a condition encoder trained to generate a structural encoding, and an image generation model trained to generate a synthetic image based on the structural encoding.

According to embodiments of the present disclosure, a machine learning system receives an input image and a text prompt to generate a synthetic image. For example, the system includes a feature extractor configured to extract a feature map from the input image. The feature map is used as structural input to the image generation model to condition the image generation process. For example, a feature encoder encodes the structural input to obtain a structural encoding. The structural encoding is combined with a noise input (e.g., the noise input for the image generation model) to obtain a combined structural encoding.

In some embodiments, the combined structural encoding is input into a condition encoder to generate layer-specific condition encodings (e.g., the structural encodings). For example, the layer-specific condition encodings are combined with the corresponding down-sampling layers of the U-Net architecture of the image generation model. In one aspect, a layer of the condition encoder includes a convolutional layer or an activation layer. After performing a number of down-sampling processes, the combined encodings are upsampled via upsampling layers to generate an output feature. In one aspect, the image generation model generates a synthetic image based on the output feature. In one aspect, the synthetic image includes a spatial structure indicated by the structural input from the input image and an element described by the text prompt.

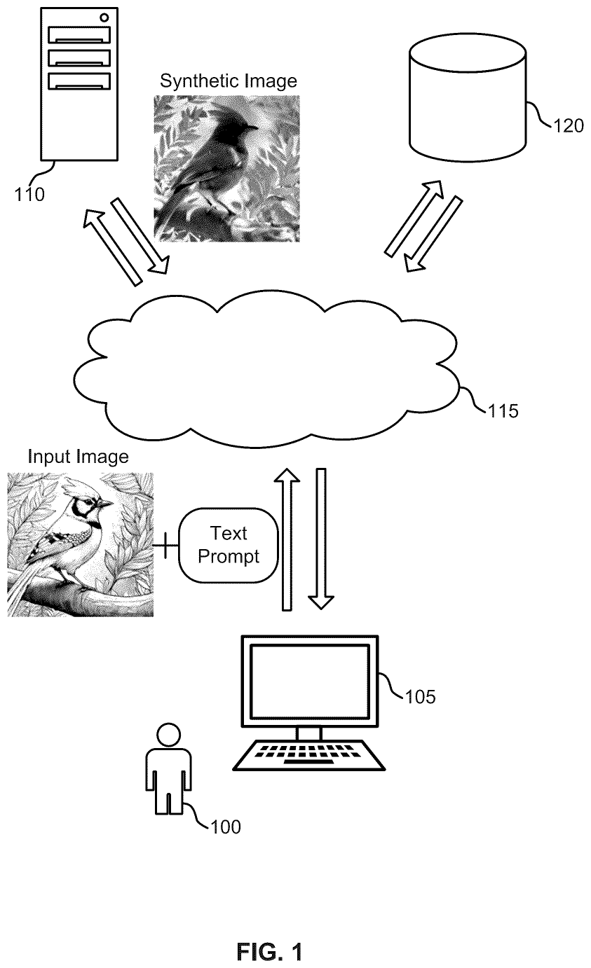

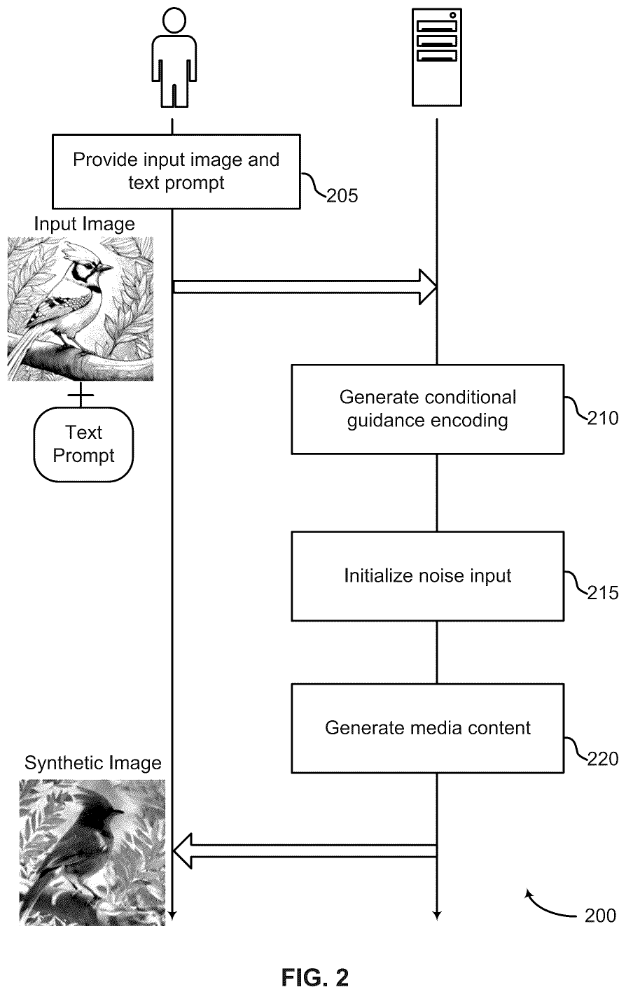

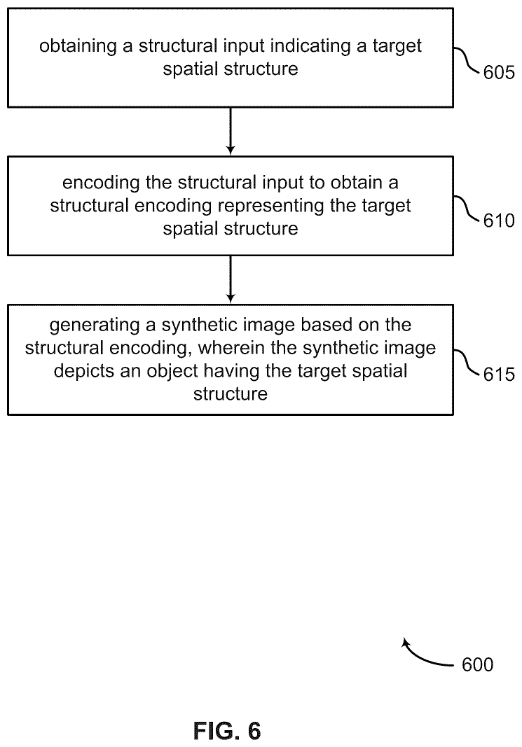

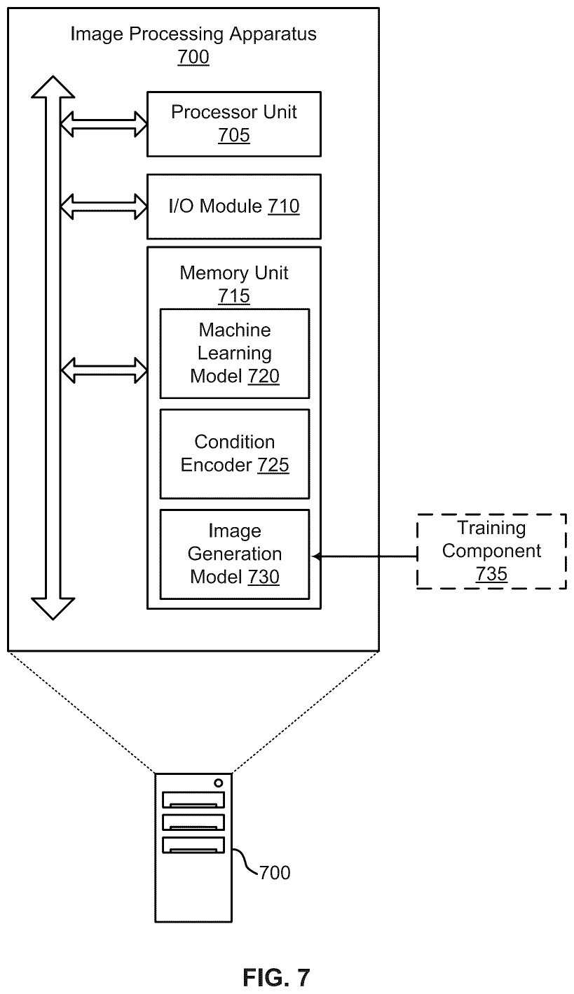

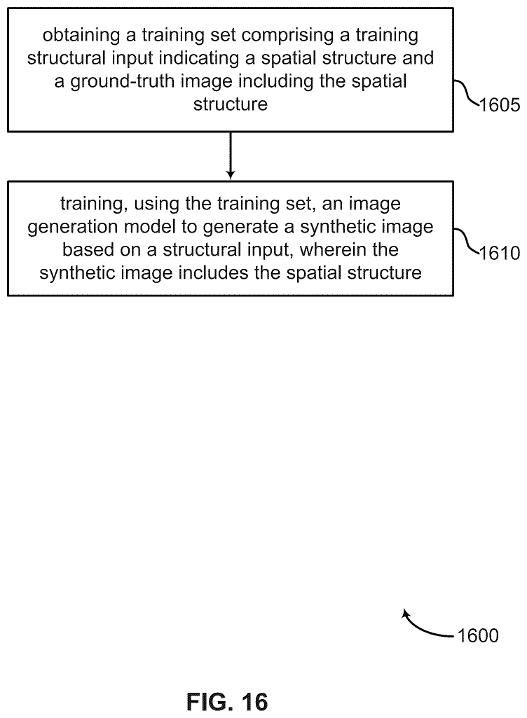

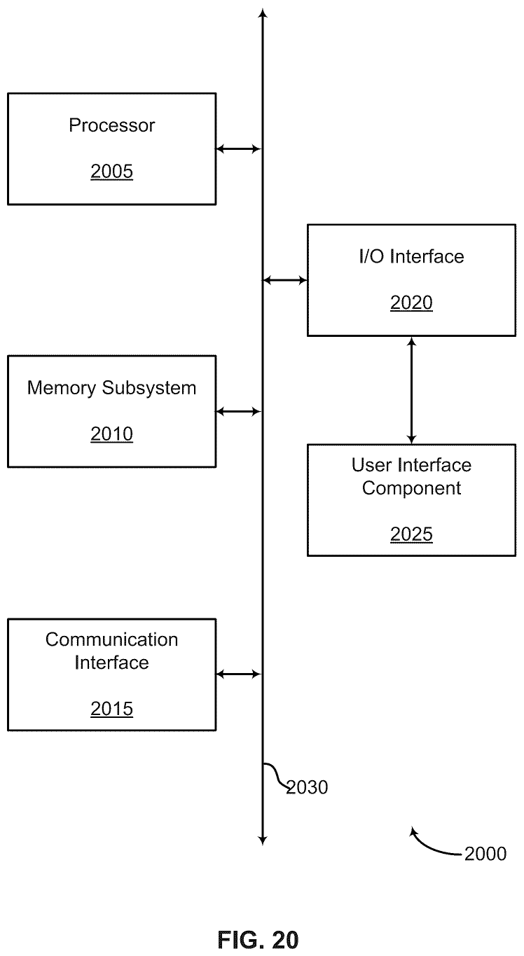

An example system of the present disclosure in image processing is provided with reference to FIGS. 1 and 20. An example application of the present disclosure in image processing is provided with reference to FIGS. 2-5. Details regarding the architecture of an image processing apparatus are provided with reference to FIGS. 7-13. An example of a process for image processing is provided with reference to FIGS. 6, and 14-15. A description of an example training process is provided with reference to FIGS. 16-19.

Accordingly, the present disclosure provides a system and a method that improve on conventional image editing systems by generating synthetic images depicting a target spatial structure more accurately and efficiently. For example, the condition encoder comprises a convolutional layer or an activation layer (instead of the additional self-attention layer and cross-attention layer included in the conventional systems). Because the condition encoder has one or more magnitudes of fewer parameters than the conventional systems, the processing time for generating a synthetic image is decreased. During training, the condition encoder and the image generation model (e.g., the U-Net) are jointly trained without increasing the training cost due to the fewer model parameters of the condition encoder. As a result, the system is able to accurately and efficiently generate the synthetic image depicting the target spatial structure.

### Image Processing

In FIGS. 1-6 and 14-15, a method, apparatus, non-transitory computer readable medium, and system for image processing include obtaining a structural input indicating a target spatial structure, encoding, using a condition encoder, the structural input to obtain a structural encoding representing the target spatial structure, and generating, using an image generation model, a synthetic image based on the structural encoding, where the synthetic image depicts an object having the target spatial structure.

Some examples of the method, apparatus, non-transitory computer readable medium, and system further include encoding each of a plurality of components of the structural input to obtain a plurality of component structural encodings, where each of the plurality of components comprises a different representation of the target spatial structure. Some examples further include combining the plurality of component structural encodings to obtain a preliminary structural encoding. Some examples further include encoding, using the condition encoder, the preliminary structural encoding to obtain the structural encoding.

In some aspects, each of the plurality of component structural encodings is generated by a different structural encoder. In some aspects, each of the plurality of component structural encodings has a different number of channels. In some aspects, the plurality of component structural encodings includes a depth encoding, an edge encoding and an entity encoding.

Some examples of the method, apparatus, non-transitory computer readable medium, and system further include providing the structural encoding to a first layer of the image generation model. Some examples further include downsampling the structural encoding to obtain a downsampled structural encoding. Some examples further include providing the downsampled structural encoding to a second layer of the image generation model.

Some examples of the method, apparatus, non-transitory computer readable medium, and system further include obtaining a noise input. Some examples further include denoising the noise input based on the structural encoding. Some examples of the method, apparatus, non-transitory computer readable medium, and system further include performing a multiple convolution process on the structural encoding.

Some examples of the method, apparatus, non-transitory computer readable medium, and system further include obtaining a structural adherence parameter, where the synthetic image is generated using the structural encoding based on the structural adherence parameter. Some examples of the method, apparatus, non-transitory computer readable medium, and system further include obtaining a text prompt describing the object, where the synthetic image is generated based on the text prompt.

Some examples of the method, apparatus, non-transitory computer readable medium, and system further include obtaining a style prompt indicating a style element, where the synthetic image is generated based on the style prompt to include the style element. Some examples of the method, apparatus, non-transitory computer readable medium, and system further include obtaining a preliminary image. Some examples further include generating the structural input is based on the preliminary image.

According to some aspects, a method, apparatus, non-transitory computer readable medium, and system for image processing are described. One or more aspects of the method, apparatus, non-transitory computer readable medium, and system include obtaining a structural input indicating a spatial structure; encoding, using a condition encoder, the structural input to obtain a structural encoding; and generating, using an image generation model, a synthetic image based on the structural encoding, wherein the synthetic image depicts an object having the spatial structure.

Some examples of the method, apparatus, non-transitory computer readable medium, and system further include obtaining a plurality of structural inputs. Some examples further include encoding each of the plurality of structural inputs to obtain a plurality of structural encodings, wherein the synthetic image is generated based on the plurality of structural encodings.

In some aspects, each of the plurality of structural encodings is generated by a different structural encoder. In some aspects, each of the plurality of structural encodings has a different number of channels. In some aspects, the plurality of structural encodings includes a depth encoding, an edge encoding and an entity encoding.

Some examples of the method, apparatus, non-transitory computer readable medium, and system further include providing the structural encoding to a first layer of the image generation model. Some examples further include downsampling the structural encoding to obtain a downsampled structural encoding. Some examples further include providing the downsampled structural encoding to a second layer of the image generation model.

Some examples of the method, apparatus, non-transitory computer readable medium, and system further include combining the structural encoding with a noise input to obtain a modified noise input, wherein the synthetic image is generated based on the modified noise input. Some examples of the method, apparatus, non-transitory computer readable medium, and system further include performing a multiple convolution process on the structural encoding.

Some examples of the method, apparatus, non-transitory computer readable medium, and system further include obtaining a structural adherence parameter, wherein the synthetic image is generated using the structural encoding based on the structural adherence parameter. Some examples of the method, apparatus, non-transitory computer readable medium, and system further include obtaining a text prompt, wherein the synthetic image is generated based on the text prompt. Some examples of the method, apparatus, non-transitory computer readable medium, and system further include obtaining a style prompt, wherein the synthetic image is generated based on the style prompt.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 7.

Referring to FIG. 1, user 100 provides an input image and a text prompt to image processing apparatus 110 via user device 105 and cloud 115. In some cases, the text prompt describes an element to be depicted in the synthetic image to be generated. In some embodiments, a machine learning model extracts a feature map from the input image as conditions to the image generation model. In some cases, the feature map indicates a spatial structure. For example, the feature map includes a depth map, an edge map, a scribble map, an entity map, or a combination thereof. The feature map is fed into a condition encoder and is combined with intermediate features of a U-Net at each down-sampling layer of encoding layers of the U-Net. Image processing apparatus 110 generates the synthetic image based on the spatial structure from the input image and depicts the image element described by the text prompt. The synthetic image is displayed to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

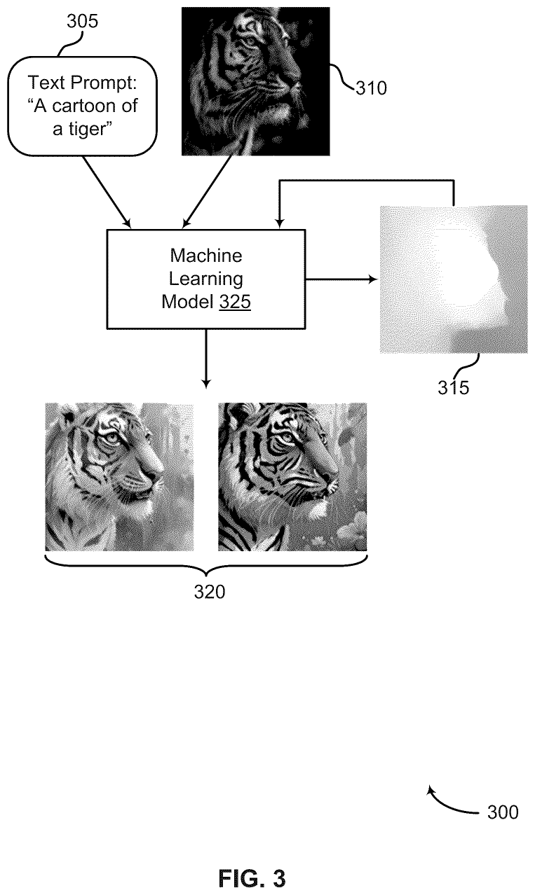

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2. User interface is an example of, or includes aspects of, the image generation system described with reference to FIGS. 3-5.

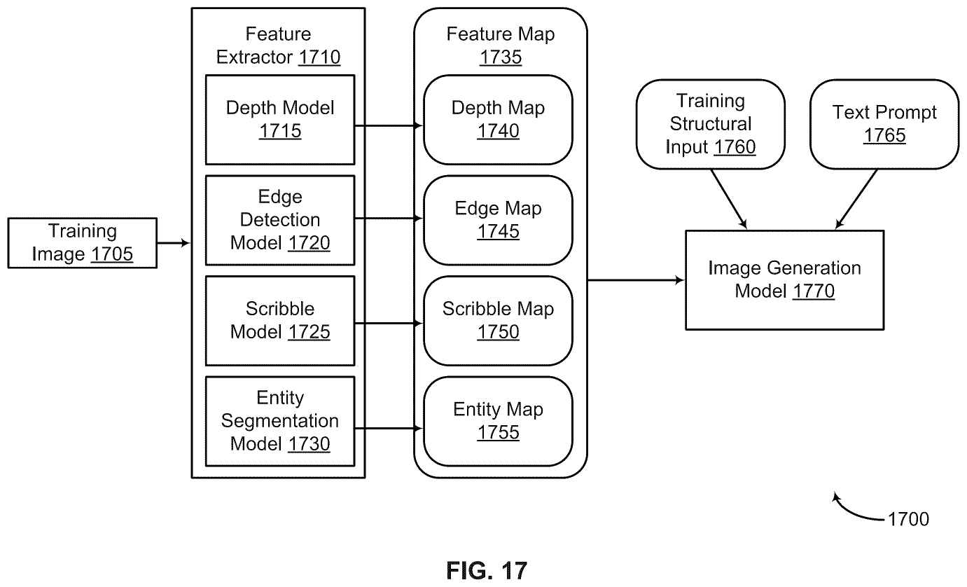

According to some aspects, image processing apparatus 110 includes a computer implemented network comprising a machine learning model, a condition encoder, and an image generation model. Image processing apparatus 110 further includes a processor unit, a memory unit, an I/O module, and a training component. In some embodiments, image processing apparatus 110 further includes a communication interface, user interface components, and a bus as described with reference to FIG. 17. Additionally, image processing apparatus 110 communicates with user device 105 and database 120 via cloud 115. Image processing apparatus 110 is an example of, or includes aspects of, the corresponding element described with reference to FIG. 7. Further detail regarding the operation of image processing apparatus 110 is provided with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including a training structural input and a ground-truth image. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for generating a synthetic image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides an input image and a text prompt. In some cases, the operations of this step refer to, or may be performed by, a user as described with reference to FIG. 1. For example, the input image depicts a black-and-white line drawing of a bird. For example, the text prompt states “a photo of a red bird sitting on a tree branch surrounded with lush green leaves.” In some cases, a style prompt indicating the style of the synthetic image may be provided to the image processing apparatus. In some cases, additional keywords, such as “photo” or “photorealistic” may be provided to the image processing apparatus. In some cases, other parameters such as aesthetic score and/or text weight may be provided to the image processing apparatus.

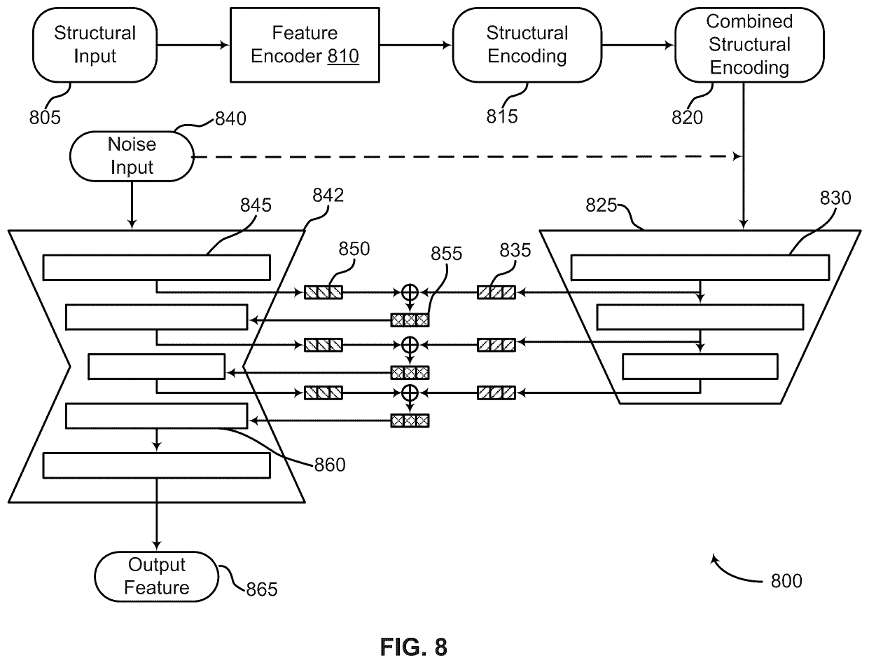

At operation 210, the system generates conditional guidance encoding. In some cases, the operations of this step refer to, or may be performed by, an image processing apparatus as described with reference to FIGS. 1 and 7. In some cases, the operations of this step refer to, or may be performed by, a condition encoder as described with reference to FIGS. 7 and 8. In some cases, for example, the system may extract one or more feature maps (e.g., the structural inputs) based on the input image. In some cases, the feature maps include a depth map, an edge map, and/or an entity map. In some cases, the system includes a feature encoder that generates structural encodings based on the structural inputs, respectively. In some embodiments, the system combines the structural encodings to obtain a combined structural encoding, where the combined structural encoding is used to guide the image generation process. Further detail on the structural encoding is described with reference to FIG. 8.

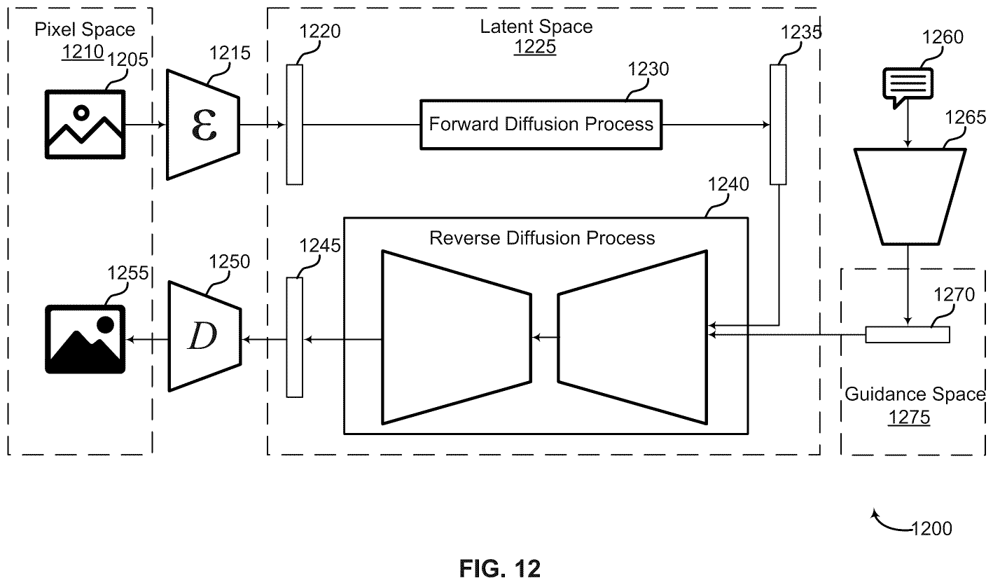

At operation 215, the system initializes noise input. In some cases, the operations of this step refer to, or may be performed by, an image processing apparatus as described with reference to FIGS. 1 and 7. In some cases, the operations of this step refer to, or may be performed by, an image generation model as described with reference to FIGS. 7, 9-11, and 17. In some cases, the noise input including random noise is initialized. The noise input may be in a latent space. By initializing the image generation model with random noise, different variations of a synthetic image including the content described by the text conditioning (e.g., the text prompt) can be generated. In some cases, a text encoding or a text embedding of the text prompt is combined with a noisy feature using a cross-attention block within the image generation model to guide the image generation process. Further detail on the image generation process is described with reference to FIG. 12.

At operation 220, the system generates media content. In some cases, the operations of this step refer to, or may be performed by, an image processing apparatus as described with reference to FIGS. 1 and 7. In some cases, the operations of this step refer to, or may be performed by, an image generation model as described with reference to FIGS. 7, 9-11, and 17. For example, the media content includes a synthetic image or a modified image each depicting a red bird surrounded by green leaves. For example, the synthetic image includes image pixels generated by the image generation model. For example, a modified image includes image pixels from the input image and image pixels generated by the image generation model. In some cases, the media content is displayed to the user via a user device.

FIG. 3 shows an example of image generation based on a depth conditioning according to aspects of the present disclosure. The example shown includes image generation system 300, text prompt 305, input image 310, depth map 315, synthetic images 320, and machine learning model 325. In some cases, the image generation system 300 may be implemented in a user interface or a user device as described with reference to FIG. 1.

Referring to FIG. 3, text prompt Error! Reference source not found.05 and input image Error! Reference source not found.10 are provided to image generation system Error! Reference source not found.00 to generate synthetic images Error! Reference source not found.20. For example, the text prompt 305 states “a cartoon of a tiger” and the input image 310 depicts a photo of a tiger. In some cases, the machine learning model 325 includes a depth model configured to extract depth map 315 from input image 310, where depth map 315 is used as structural input to condition the image generation process. As shown in FIG. 3, synthetic images 320 have the same spatial structure as the input image 310. In some cases, synthetic images 320 depict one or more elements described by text prompt 305. In some cases, synthetic images 320 include image variations of the tiger. Further detail on the image generation process is described with reference to FIG. 8.

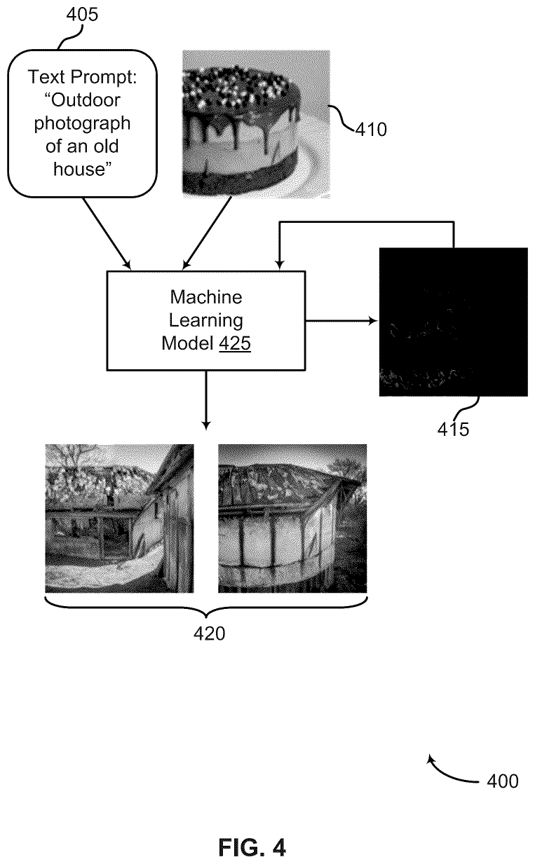

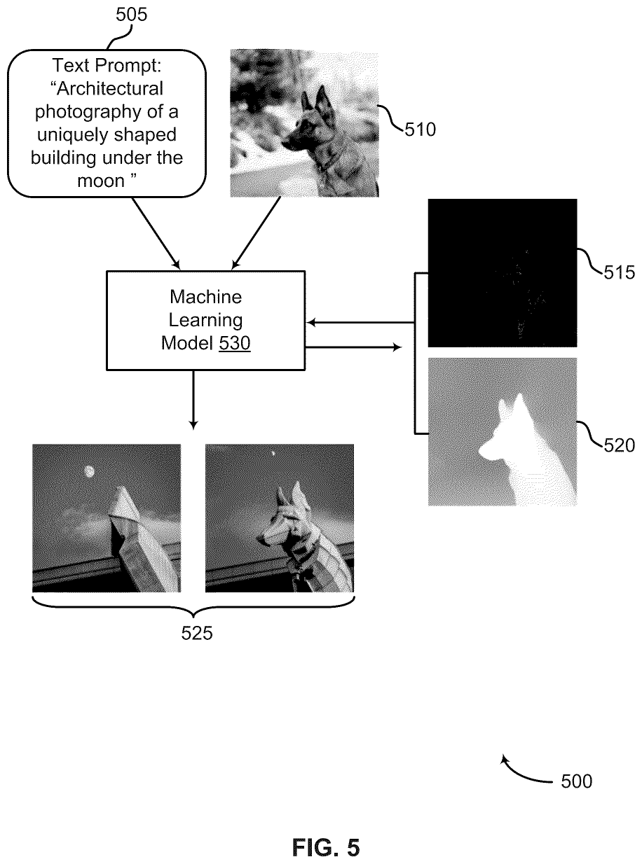

Image generation system 300 is an example of, or includes aspects of, the corresponding element described with reference to FIGS. 4 and 5. Text prompt 305 is an example of, or includes aspects of, the corresponding element described with reference to FIGS. 4, 5, 9-11, and 17. Input image 310 is an example of, or includes aspects of, the corresponding element described with reference to FIGS. 4, 5, 9, and 10.

Depth map 315 is an example of, or includes aspects of, the corresponding element described with reference to FIGS. 5, 9, and 17. Synthetic images 320 are an example of, or includes aspects of, the corresponding element described with reference to FIGS. 4 and 5. Machine learning model 325 is an example of, or includes aspects of, the corresponding element described with reference to FIGS. 4, 5, 7, and 8.

FIG. 4 shows an example of image generation based on an edge conditioning according to aspects of the present disclosure. The example shown includes image generation system 400, text prompt 405, input image 410, edge map 415, synthetic images 420, and machine learning model 425. In some cases, the image generation system 400 may be implemented in a user interface or a user device as described with reference to FIG. 1.

Referring to FIG. 4, text prompt 405 and input image 410 are provided to image generation system 400 to generate synthetic images 420. For example, the text prompt 405 states “outdoor photograph of an old house” and the input image 410 depicts a cake. In some cases, the machine learning model 425 includes an edge model configured to extract edge map 415 from input image 410, where edge map 415 is used as structural input to condition the image generation process. As shown in FIG. 4, synthetic images 420 have the same spatial structure as the input image 410. In some cases, synthetic images 420 depict one or more elements described by text prompt 405. In some cases, synthetic images 420 includes image variations of the old house. Further detail on the image generation process is described with reference to FIG. 8.

Image generation system 400 is an example of, or includes aspects of, the corresponding element described with reference to FIGS. 3 and 5. Text prompt 405 is an example of, or includes aspects of, the corresponding element described with reference to FIGS. 3, 5, 9-11, and 17. Input image 410 is an example of, or includes aspects of, the corresponding element described with reference to FIGS. 3, 5, 9, and 10.

Edge map 415 is an example of, or includes aspects of, the corresponding element described with reference to FIGS. 5, 9, and 17. Synthetic images 420 are an example of, or includes aspects of, the corresponding element described with reference to FIGS. 3 and 5. Machine learning model 425 is an example of, or includes aspects of, the corresponding element described with reference to FIGS. 3, 5, 7, and 8.

FIG. 5 shows an example of image generation based on various levels of structure adherence according to aspects of the present disclosure. The example shown includes image generation system 500, text prompt 505, input image 510, edge map 515, depth map 520, synthetic images 525, and machine learning model 530. In some cases, the image generation system 500 may be implemented in a user interface or a user device as described with reference to FIG. 1.

Referring to FIG. 5, text prompt 505 and input image 510 are provided to the image generation system 500 to generate synthetic images 525. For example, the text prompt 505 states “architectural photography of a uniquely shaped building under the moon” and the input image 510 depicts a dog. In some cases, the machine learning model 530 includes an edge model and a depth model each configured to extract edge map 515 and depth map 520, respectively, from the input image 510, where edge map 515 and depth map 520 are used as structural inputs to condition the image generation process. As shown in FIG. 5, synthetic images 525 have the same spatial structure as the input image 510. In some cases, synthetic images 525 depict one or more elements described by text prompt 505. In some cases, synthetic images 525 include image variations of the uniquely shaped building. Further detail on the image generation process is described with reference to FIG. 8.

Image generation system 500 is an example of, or includes aspects of, the corresponding element described with reference to FIGS. 3 and 4. Text prompt 505 is an example of, or includes aspects of, the corresponding element described with reference to FIGS. 3, 4, 9-11, and 17. Input image 510 is an example of, or includes aspects of, the corresponding element described with reference to FIGS. 3, 4, 9, and 10.

Edge map 515 is an example of, or includes aspects of, the corresponding element described with reference to FIGS. 4, 9, and 17. Depth map 520 is an example of, or includes aspects of, the corresponding element described with reference to FIGS. 3, 9, and 17. Synthetic images 525 are an example of, or includes aspects of, the corresponding element described with reference to FIGS. 3 and 4. Machine learning model 530 is an example of, or includes aspects of, the corresponding element described with reference to FIGS. 3, 4, 7, and 8.

FIG. 6 shows an example of a method 600 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains a structural input indicating a target spatial structure. In some cases, the operations of this step refer to, or may be performed by, a machine learning model as described with reference to FIGS. 3-5, 7, and 8. In some cases, structural input includes a depth map, an edge map, and an entity map. For example, the depth map is a grayscale image where each pixel encodes the distance or depth of the corresponding point in a scene. The depth map represents the spatial layout of objects in a scene based on the distance from a viewpoint. For example, an edge map is a binary or grayscale image indicating the boundaries or edges of objects within a scene. Each pixel in the edge map represents the presence or strength of an edge in the corresponding location of the input image. For example, an entity map highlights an entity (e.g., object, person, background scene, etc.) within the input image. In some cases, the entity map is represented in RGB color maps.

In some cases, spatial structure or target spatial structure refers to the arrangement and layout of visual elements within an image. For example, spatial structure includes characteristics such as spatial patterns or spatial relationships of objects, regions, or features. In some cases, spatial structure can be encoded in a depth map, an edge map, and an entity map.

In some cases, for example, an image element is an image component or image feature that makes up the overall composition of an image, such as an object, entity, subject, shape, color, texture, pattern, background scene, visual attributes, and/or style. For example, the image element may be an animal such as a cat or dog, a person, an object such as a hat or table, a scene such as a beach or mountain top, or a combination thereof. In some cases, for example, an image element may indicate a configuration, a style, a color scheme, a lighting effect, a perspective, a view angle, a texture, or a composition rule of an image.

At operation 610, the system encodes, using a condition encoder, the structural input to obtain a structural encoding representing the target spatial structure. In some cases, the operations of this step refer to, or may be performed by, a condition encoder as described with reference to FIGS. 7 and 8. In some cases, by converting (encoding or embedding) the input into an encoding, the machine learning model is able to process the data more easily. In some cases, the encodings include vector representation of inputs. In some cases, the encodings are in a numerical format which allows the machine learning model to process the data more efficiently and effectively. In some cases, encoding may be a latent representation or latent code. In some cases, encoding may include a feature map. In some cases, conditioning refers to the process of incorporating additional information or constraints into a machine learning model such that the output (usually a synthetic image) closely follows the additional information.

At operation 615, the system generates, using an image generation model, a synthetic image based on the structural encoding, where the synthetic image depicts an object having the target spatial structure. In some cases, the operations of this step refer to, or may be performed by, an image generation model as described with reference to FIGS. 7, 9-11, and 17. In some cases, the system may generate a modified image based on the structural encoding. For example, the synthetic image includes image pixels generated by the image generation model. For example, the modified image includes image pixels from the input image and image pixels generated by the image generation model.

### System Architecture

In FIGS. 7-13 and 20, an apparatus and system for image processing include a memory component, and a processing device coupled to the memory component, the processing device is configured to perform operations comprising: obtaining a structural input indicating a target spatial structure, encoding, using a condition encoder, the structural input to obtain a structural encoding representing the target spatial structure, and generating, using an image generation model, a synthetic image based on the structural encoding, where the synthetic image depicts an object having the target spatial structure.

In some aspects, the condition encoder comprises a plurality of convolutional layers and a plurality of activation layers. In some aspects, the image generation model comprises more parameters than the condition encoder. Some examples of the apparatus and system further include a text encoder configured to encode a text prompt to obtain a text embedding.

According to some aspects, an apparatus and system for image processing are described. One or more aspects of the apparatus and system include at least one processor; at least one memory storing instructions executable by the at least one processor; a condition encoder comprising parameters stored in the at least one memory and trained to encode a structural input to obtain a structural encoding, wherein the structural input indicates a spatial structure; and an image generation model comprising parameters stored in the at least one memory and trained to generate a synthetic image based on the structural encoding, wherein the synthetic image depicts an object having the spatial structure.

In some aspects, each layer of the condition encoder comprises a convolutional layer or an activation layer. In some aspects, the image generation model comprises at least ten times more parameters than the condition encoder. Some examples of the apparatus and system further include a text encoder configured to encode a text prompt to obtain a text embedding.

FIG. 7 shows an example of an image processing apparatus 700 according to aspects of the present disclosure. The example shown includes image processing apparatus 700, processor unit 705, I/O module 710, memory unit 715, and training component 735.

According to some embodiments of the present disclosure, image processing apparatus 700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 700 is an example of, or includes aspects of, the corresponding element described with reference to FIG. 1.

Processor unit 705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special-purpose components for modem processing, baseband processing, digital signal processing, or transmission processing. Processor unit 705 is an example of, or includes aspects of, the processor described with reference to FIG. 20.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 710 is an example of, or includes aspects of, the I/O interface described with reference to FIG. 20.

Examples of memory unit 715 include random access memory (RAM), read-only memory (ROM), or a hard disk. Examples of memory unit 715 include solid-state memory and a hard disk drive. In some examples, memory unit 715 is used to store computer-readable, computer-executable software including instructions that, when executed, cause a processor to perform various functions described herein.

In some cases, memory unit 715 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 715 store information in the form of a logical state.

In one aspect, memory unit 715 includes machine learning model 720, condition encoder 725, and image generation model 730. In some aspects, machine learning model 720 includes the condition encoder 725 and the image generation model 730. Memory unit 715 is an example, of, or includes aspects of, the memory subsystem described with reference to FIG. 20.

In some cases, machine learning model 720 is a computational algorithm, model, or system designed to recognize patterns, make predictions, or perform a specific task (for example, image processing) without being explicitly programmed. According to some aspects, machine learning model 720 is implemented as software stored in memory unit 715 and executable by processor unit 705, as firmware, as one or more hardware circuits, or as a combination thereof.

According to some embodiments of the present disclosure, machine learning model 720 includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model 720 includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model 720 includes machine learning parameters. Machine learning parameters, also known as model parameters or weights, are variables that provide behavior and characteristics of machine learning model 720. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow machine learning model 720 to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model 720 includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, machine learning model 720 includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, machine learning model 720 obtains a structural input indicating a target spatial structure. In some examples, machine learning model 720 encodes each of a set of components of the structural input to obtain a set of component structural encodings, where each of the set of components includes a different representation of the target spatial structure. In some examples, machine learning model 720 combines the set of component structural encodings to obtain a preliminary structural encoding.

In some examples, machine learning model 720 provides the structural encoding to a first layer of the image generation model. In some examples, machine learning model 720 obtains a structural adherence parameter, where the synthetic image is generated using the structural encoding based on the structural adherence parameter. In some examples, machine learning model 720 obtains a text prompt describing the object, where the synthetic image is generated based on the text prompt.

In some examples, machine learning model 720 obtains a style prompt indicating a style element, where the synthetic image is generated based on the style prompt to include the style element. In some examples, machine learning model 720 obtains a preliminary image. In some examples, machine learning model 720 generates the structural input is based on the preliminary image. Machine learning model 720 is an example of, or includes aspects of, the corresponding element described with reference to FIGS. 3-5, and 8.

According to some aspects, machine learning model Error! Reference source not found.20 obtains a structural input indicating a spatial structure. In some examples, machine learning model Error! Reference source not found.20 obtains a set of structural inputs. In some examples, machine learning model Error! Reference source not found.20 obtains a structural adherence parameter, where the synthetic image is generated using the structural encoding based on the structural adherence parameter.

In some examples, machine learning model Error! Reference source not found.20 obtains a text prompt, where the synthetic image is generated based on the text prompt. In some examples, machine learning model Error! Reference source not found.20 obtains a style prompt, where the synthetic image is generated based on the style prompt.

According to some aspects, condition encoder Error! Reference source not found.25 is implemented as software stored in memory unit 715 and executable by processor unit 705, as firmware, as one or more hardware circuits, or as a combination thereof. According to some aspects, condition encoder 725 encodes the structural input to obtain a structural encoding representing the target spatial structure. In some examples, condition encoder 725 encodes the preliminary structural encoding to obtain the structural encoding. In some aspects, each of the set of component structural encodings is generated by a different structural encoder. In some aspects, each of the set of component structural encodings has a different number of channels.

In some aspects, the set of component structural encodings includes a depth encoding, an edge encoding and an entity encoding. In some examples, condition encoder 725 downsamples the structural encoding to obtain a downsampled structural encoding. In some examples, condition encoder 725 provides the downsampled structural encoding to a second layer of the image generation model 730. In some examples, condition encoder 725 performs a multiple convolution process on the structural encoding.

According to some aspects, condition encoder 725 generates a structural encoding based on the structural input. In some aspects, the condition encoder 725 includes a set of convolutional layers and a set of activation layers. Condition encoder 725 is an example of, or includes aspects of, the corresponding element described with reference to FIG. 8.

According to some aspects, condition encoder Error! Reference source not found.25 encodes the structural input to obtain a structural encoding. In some examples, condition encoder Error! Reference source not found.25 encodes each of the set of structural inputs to obtain a set of structural encodings, where the synthetic image is generated based on the set of structural encodings. In some aspects, each of the set of structural encodings is generated by a different structural encoder. In some aspects, each of the set of structural encodings has a different number of channels. In some aspects, the set of structural encodings includes a depth encoding, an edge encoding and an entity encoding. In some examples, condition encoder Error! Reference source not found.25 performs a multiple convolution process on the structural encoding. According to some aspects, condition encoder Error! Reference source not found.25 comprises parameters stored in the at least one memory and trained to encode a structural input to obtain a structural encoding, wherein the structural input indicates a spatial structure. In some aspects, each layer of the condition encoder Error! Reference source not found.25 includes a convolutional layer or an activation layer.

According to some aspects, image generation model Error! Reference source not found.30 is implemented as software stored in memory unit 715 and executable by processor unit 705, as firmware, as one or more hardware circuits, or as a combination thereof. According to some aspects, image generation model 730 generates a synthetic image based on the structural encoding, where the synthetic image depicts an object having the target spatial structure. In some examples, image generation model 730 obtains a noise input. In some examples, image generation model 730 denoises the noise input based on the structural encoding. In some aspects, the image generation model 730 is trained using a training set including a training structural input indicating a spatial structural and a ground-truth image including the target spatial structure.

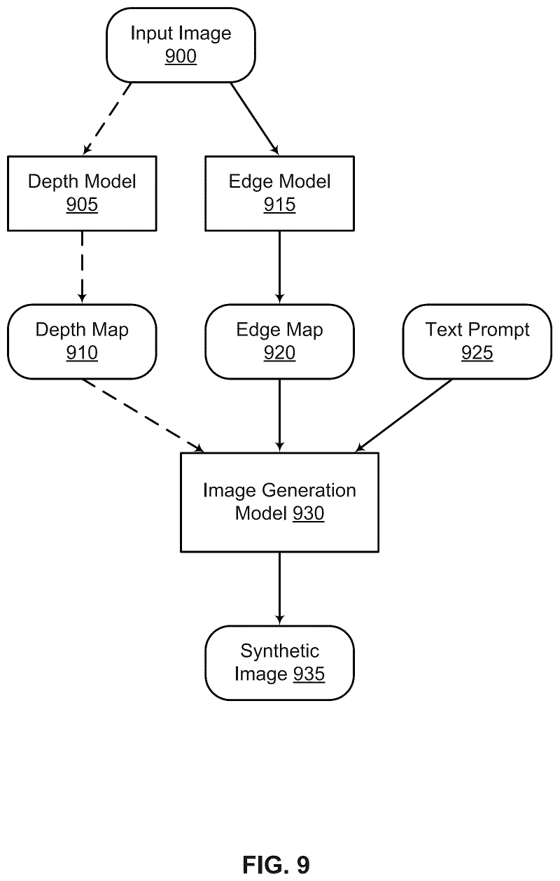

According to some aspects, image generation model 730 generates a predicted image based on the structural encoding. According to some aspects, image generation model 730 generates a synthetic image based on the structural encoding, where the synthetic image depicts an object having the target spatial structure. In some aspects, the image generation model 730 includes more parameters than the condition encoder 725. Image generation model 730 is an example of, or includes aspects of, the corresponding element described with reference to FIGS. 9-11, and 17. Image generation model 730 is an example of, or includes aspects of, the diffusion model described with reference to FIG. 12.

According to some aspects, image generation model Error! Reference source not found.30 generates a synthetic image based on the structural encoding, where the synthetic image depicts an object having the spatial structure. In some examples, image generation model Error! Reference source not found.30 provides the structural encoding to a first layer of the image generation model Error! Reference source not found.30. In some examples, image generation model Error! Reference source not found.30 down-samples the structural encoding to obtain a downsampled structural encoding. In some examples, image generation model Error! Reference source not found.30 provides the downsampled structural encoding to a second layer of the image generation model Error! Reference source not found.30. In some examples, image generation model Error! Reference source not found.30 combines the structural encoding with a noise input to obtain a modified noise input, where the synthetic image is generated based on the modified noise input.

According to some aspects, image generation model Error! Reference source not found.30 comprises parameters stored in the at least one memory and trained to generate a synthetic image based on the structural encoding, wherein the synthetic image depicts an object having the spatial structure. In some aspects, the image generation model Error! Reference source not found.30 includes at least ten times more parameter than the condition encoder Error! Reference source not found.25.

According to some aspects, training component 735 is implemented as software stored in memory unit 715 and executable by processor unit 705, as firmware, as one or more hardware circuits, or as a combination thereof. According to some embodiments, training component 735 is implemented as software stored in a memory unit and executable by a processor in the processor unit of a separate computing device, as firmware in the separate computing device, as one or more hardware circuits of the separate computing device, or as a combination thereof. In some examples, training component 735 is part of another apparatus other than image processing apparatus 700 and communicates with the image processing apparatus 700. In some examples, training component 735 is part of image processing apparatus 700.

According to some aspects, training component 735 obtains a training set including a training structural input indicating a spatial structure and a ground-truth image including the spatial structure. In some examples, training component 735 trains, using the training set, an image generation model 730 to generate a synthetic image based on a structural input, where the synthetic image includes the spatial structure. In some examples, training component 735 jointly trains a condition encoder 725 together with the image generation model 730. In some examples, training component 735 computes a loss function by comparing the predicted image with the ground-truth image. In some examples, training component 735 updates parameters of the image generation model 730 based on the loss function.

According to some aspects, training component Error! Reference source not found.35 obtains a training set including a training structure input and a ground truth image. In some examples, training component Error! Reference source not found.35 trains, using the training set, a machine learning model Error! Reference source not found.20 to generate a synthetic image based on a structure input. In some examples, training component Error! Reference source not found.35 jointly trains a condition encoder Error! Reference source not found.25 and an image generation model Error! Reference source not found.30.

FIG. 8 shows an example of a machine learning model 800 according to aspects of the present disclosure. The example shown includes machine learning model 800, structural input 805, feature encoder 810, structural encoding 815, combined structural encoding 820, condition encoder 825, condition encoding layer 830, down-sampled encoding 835, noise input 840, image generation model 842, convolutional layer 845, down-sampled feature 850, combined down-sampled feature 855, upsampling layer 860, and output feature 865. In one aspect, machine learning model 800 includes feature encoder 810, condition encoder 825, and image generation model 842. In one aspect, condition encoder 825 include condition encoding layer 830. In one aspect, image generation model 842 includes one or more convolutional layers 845 and one or more upsampling layers 860.

Referring to FIG. 8, machine learning model 800 receives an input image and a text prompt to generate a synthetic image. For example, a feature extractor extracts one or more feature maps from the input image. In some cases, the feature maps are used as structural input Error! Reference source not found.05. In some cases, the feature extractor includes a depth model, edge model, or entity segmentation model. In some cases, structural input Error! Reference source not found.05 includes a depth map, edge map, and entity map. In some cases, for example, the depth map may have a dimension of 1×1024×1024. For example, the edge map may have a dimension of 2×1024×1024. For example, the entity map has a dimension of 3×1024×1024.

Each of the structural inputs is provided to a feature encoder 810, where the feature encoder 810 encodes structural input Error! Reference source not found.05 to obtain structural encoding 815. In some cases, for example, feature encoder 810 includes a depth encoder, an edge encoder, or an entity encoder. In one aspect, the feature encoder 810 includes one or more convolutional blocks and/or one or more down-sampling layers. In some cases, structural encoding Error! Reference source not found.15 has a smaller dimension than the structural input Error! Reference source not found.05. For example, the structural encoding 815 may have a dimension of 3×1024×1024. In some cases, structural encoding Error! Reference source not found.15 for each of the different structural inputs has the same number of channels (e.g., three channels).

In some embodiments, each of the structural encodings is combined to form combined structural encoding Error! Reference source not found.20. In one embodiment, noise input 840 is combined with the structural encodings to generate combined structural encoding Error! Reference source not found.20. Then, the combined structural encoding Error! Reference source not found.20 is input into condition encoder 825. For example, combined structural encoding Error! Reference source not found.20 passes through a condition encoding layer 830 of condition encoder 825. In some cases, the condition encoding layer 830 outputs down-sampled encoding Error! Reference source not found.35 (or a first down-sampled encoding). In one aspect, condition encoding layer 830 includes one or more convolutional layers or one or more activation layers. For example, the activation layer is a sigmoid activation layer that maps the input to a range between 0 and 1 using the sigmoid function, where the output can be interpreted as probabilities.

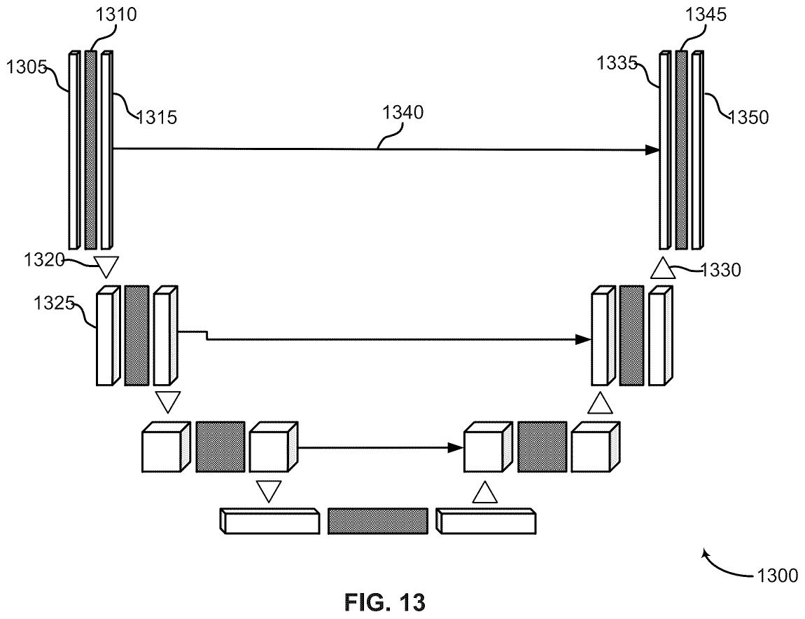

In some embodiments, noise input Error! Reference source not found.40 is input into a convolutional layer 845 of a U-Net (e.g., the U-Net described with reference to FIG. 13) of an image generation model 842. In response, convolutional layer 845 generates down-sampled feature Error! Reference source not found.50. For example, down-sampled feature Error! Reference source not found.50 has the same dimension as noise input 840 (e.g., 128×128). In some cases, the number of channels is expanded in down-sampled feature Error! Reference source not found.50 (e.g., from 12 to 320). Then, down-sampled feature Error! Reference source not found.50 is combined with down-sampled encoding Error! Reference source not found.35 from condition encoder Error! Reference source not found.25 to generate the combined down-sampled feature Error! Reference source not found.55 (e.g., a first combined down-sampled feature).

In some embodiments, the down-sampling process is repeated a number of times (e.g., a total of three times). For example, the first down-sampled encoding is input into condition encoding layer 830 (e.g., a second condition encoding layer) to generate a second down-sampled encoding, where the dimension of the second down-sampled encoding is reduced by half (e.g., from 128×128 to 64×64). Similarly, the first combined down-sampled feature is input into a second convolution layer to generate the second down-sampled feature. The dimension of the second down-sampled feature is reduced by half (e.g., from 128×128 to 64×64). Then, the second down-sampled encoding generated by the condition encoder 825 and the second down-sampled feature generated by the image generation model 842 are combined to form the second combined down-sampled feature.

In some embodiments, after the down-sampling process, the combined down-sampled feature 855 is fed into an upsampling layer 860 of the U-Net of the image generation model 842. In some cases, upsampling layer 860 includes the same number of upsampling layers as the number of down-sampling layers. For example, the U-Net architecture includes two down-sampling layers and two up-sampling layers. In some cases, the U-Net architecture includes a middle layer between the down-sampling layer and the upsampling layer. In the final upsampling step, upsampling layer 860 generates output feature 865 based on the combined down-sampled feature 855. In some embodiments, output feature 865 is input into an image decoder (as described with reference to FIG. 12) to generate the synthetic image.

According to some embodiments, the text prompt is used as guidance to the image generation model 842. For example, the text prompt can be encoded using a text encoder to obtain a guidance feature in the guidance space. The guidance feature can be combined with the noisy features (e.g., noise input 840) at one or more layers of the reverse diffusion process, so that the synthetic image includes contents described by the text prompt. For example, the guidance feature from the text prompt is combined with noise input 840 using cross-attention block within the reverse diffusion process of the image generation model 842.

In some embodiments, the image generation model 842 receives a style prompt describing a style to generate the synthetic image that includes an element corresponding to the style described by the style prompt. In some embodiments, the image generation model 842 includes multiple levels of structure adherence.

According to some aspects, the image generation model 842 of the present disclosure includes a U-Net architecture with residual connections. For example, the U-Net architecture may be separated into three blocks: input block, middle block, and output block. In some cases, the input block includes one or more convolutional layers 845. In some cases, the middle block includes a middle layer. In some cases, the output block includes one or more upsampling layers 860. For example, the input block includes multiple blocks and a down-sample layer after every “n” number of blocks.

In some cases, the machine learning model 800 receives one or more of the three input conditions (e.g., the structural input 805): depth, edge, or entity. The input conditions are spatial conditions that have the shape of the original image and with 1, 2, and 3 channels, respectively. For each input condition, the feature encoder 810 includes a lightweight network comprising ResBlocks and downsample layers, where the output of the structural encoder has the same shape as the input latent (e.g., the noise input 840) to the U-Net.

In some embodiments, the conditions are channel-wisely concatenated to a noised input (e.g., the noise input 840) to obtain a combined encoding (e.g., the combined structural encoding 820). The combined encoding is passed through a set of convolutional blocks and down-sample layers. In one embodiment, the combined encoding is down-sampled three times to obtain an intermediate output, where the intermediate output is stored. Then, the intermediate output is added after the three down-sample layers in the U-Net. Accordingly, the U-Net learns to adhere to the input conditions.

Machine learning model 800 is an example of, or includes aspects of, the corresponding element described with reference to FIGS. 3-5, and 7. Condition encoder 825 is an example of, or includes aspects of, the corresponding element described with reference to FIG. 7.

FIG. 9 shows an example of image generation based on a reference image according to aspects of the present disclosure. The example shown includes input image 900, depth model 905, depth map 910, edge model 915, edge map 920, text prompt 925, image generation model 930, and synthetic image 935.

Referring to FIG. 9, image generation model 930 receives input image 900 and generates synthetic image 935. For example, input image 900 is provided to depth model 905 to generate depth map 910. Alternatively, input image 900 is provided to edge model 915 to generate edge map 920. In one embodiment, image generation model 930 receives depth map 910 and text prompt 925 to generate synthetic image 935. In one embodiment, image generation model 930 receives edge map 920 and text prompt 925 to generate synthetic image 935. In one embodiment, the image generation model 930 receives depth map 910, edge map 920, and text prompt 925 to generate synthetic image 935.

Input image 900 is an example of, or includes aspects of, the corresponding element described with reference to FIGS. 3-5, and 10. Depth model 905 is an example of, or includes aspects of, the corresponding element described with reference to FIG. 17. Depth map 910 is an example of, or includes aspects of, the corresponding element described with reference to FIGS. 3, 5, and 17.

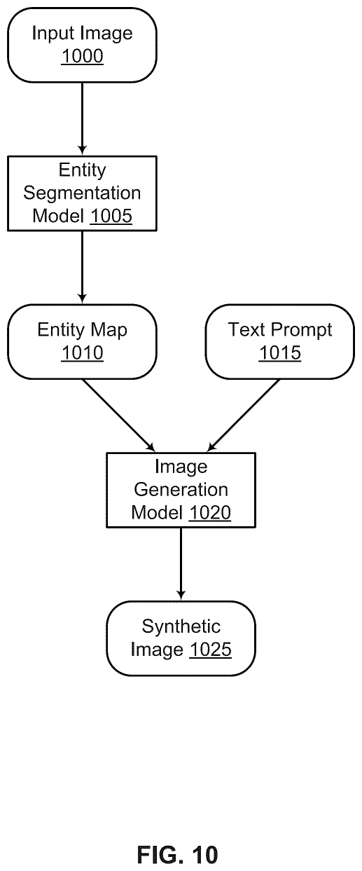

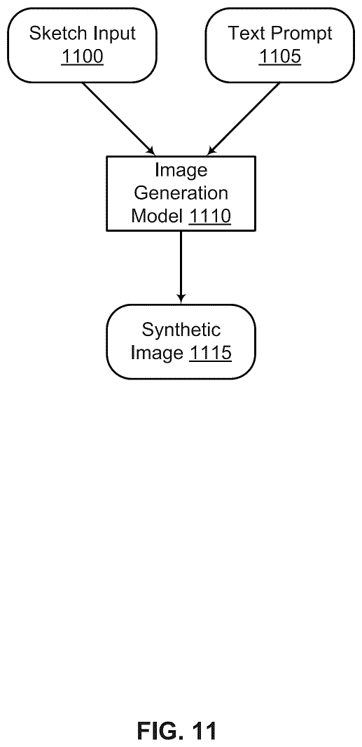

Edge map 920 is an example of, or includes aspects of, the corresponding element described with reference to FIGS. 4, 5, and 17. Text prompt 925 is an example of, or includes aspects of, the corresponding element described with reference to FIGS. 3-5, 10, 11, and 17. Image generation model 930 is an example of, or includes aspects of, the corresponding element described with reference to FIGS. 7, 10, 11, and 17. Synthetic image 935 is an example of, or includes aspects of, the corresponding element described with reference to FIGS. 10 and 11.

FIG. 10 shows an example of image generation based on entity control according to aspects of the present disclosure. The example shown includes input image 1000, entity segmentation model 1005, entity map 1010, text prompt 1015, image generation model 1020, and synthetic image 1025.

Referring to FIG. 10, image generation model 1020 receives input image 1000 and generates synthetic image 1025 based on input image 1000. For example, input image 1000 is provided to entity segmentation model 1005 to generate entity map 1010. In some cases, entity map 1010 includes one or more pixels representing an object within a scene of input image 1000. Image generation model 1020 receives entity map 1010 and text prompt 1015 to generate synthetic image 1025.

Input image 1000 is an example of, or includes aspects of, the corresponding element described with reference to FIGS. 3-5, and 9. Entity segmentation model 1005 is an example of, or includes aspects of, the corresponding element described with reference to FIG. 17. Entity map 1010 is an example of, or includes aspects of, the corresponding element described with reference to FIG. 17.

Text prompt 1015 is an example of, or includes aspects of, the corresponding element described with reference to FIGS. 3-5, 9, 11, and 17. Image generation model 1020 is an example of, or includes aspects of, the corresponding element described with reference to FIGS. 7, 9, 11, and 17. Synthetic image 1025 is an example of, or includes aspects of, the corresponding element described with reference to FIGS. 9 and 11.

FIG. 11 shows an example of image generation based on user sketch according to aspects of the present disclosure. The example shown includes sketch input 1100, text prompt 1105, image generation model 1110, and synthetic image 1115.

Referring to FIG. 11, image generation model 1110 receives sketch input 1100 and text prompt 1105 to generate synthetic image 1115. In some cases, the system may generate one or more of the structural inputs based on the sketch input 1100. For example, the structural inputs include one or more of the combination of a depth map, edge map, and entity map. The image generation model 1110 generates the synthetic image 1115 using the image generation process as described with reference to FIG. 8 based on the structural inputs and the text prompt 1105.

Text prompt 1105 is an example of, or includes aspects of, the corresponding element described with reference to FIGS. 3-5, 9, 10, and 17. Image generation model 1110 is an example of, or includes aspects of, the corresponding element described with reference to FIGS. 7, 9, 10, and 17. Synthetic image 1115 is an example of, or includes aspects of, the corresponding element described with reference to FIGS. 9 and 10.

FIG. 12 shows an example of an image generation model according to aspects of the present disclosure. The example shown includes diffusion model 1200, original image 1205, pixel space 1210, image encoder 1215, original image feature 1220, latent space 1225, forward diffusion process 1230, noisy feature 1235, reverse diffusion process 1240, denoised image feature 1245, image decoder 1250, output image 1255, text prompt 1260, text encoder 1265, guidance feature 1270, and guidance space 1275.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image, or to image features generated by an encoder (e.g., latent diffusion).

Diffusion models work by iteratively adding noise to the data during a forward process and then learning to recover the data by denoising the data during a reverse process. For example, during training, diffusion model 1200 may take an original image 1205 in a pixel space 1210 as input and apply an image encoder 1215 to convert original image 1205 into original image feature 1220 in a latent space 1225. Then, a forward diffusion process 1230 gradually adds noise to the original image feature 1220 to obtain noisy feature 1235 (also in latent space 1225) at various noise levels.

Next, a reverse diffusion process 1240 (e.g., a U-Net ANN) gradually removes the noise from the noisy feature 1235 at the various noise levels to obtain the denoised image feature 1245 in latent space 1225. In some examples, denoised image feature 1245 is compared to the original image feature 1220 at each of the various noise levels, and parameters of the reverse diffusion process 1240 of the diffusion model are updated based on the comparison. Finally, an image decoder 1250 decodes the denoised image feature 1245 to obtain an output image 1255 in pixel space 1210. In some cases, an output image 1255 is created at each of the various noise levels. The output image 1255 can be compared to the original image 1205 to train the reverse diffusion process 1240. In some cases, output image 1255 refers to the synthetic image (e.g., described with reference to FIGS. 3-5).

In some cases, image encoder 1215 and image decoder 1250 are pre-trained prior to training the reverse diffusion process 1240. In some examples, image encoder 1215 and image decoder 1250 are trained jointly, or the image encoder 1215 and image decoder 1250 are fine-tuned jointly with the reverse diffusion process 1240.

The reverse diffusion process 1240 can also be guided based on a text prompt 1260, or another guidance prompt, such as an image, a layout, a style, a color, a segmentation map, etc. The text prompt 1260 can be encoded using a text encoder 1265 (e.g., a multimodal encoder) to obtain guidance feature 1270 in guidance space 1275. The guidance feature 1270 can be combined with the noisy feature 1235 at one or more layers of the reverse diffusion process 1240 to ensure that the output image 1255 includes content described by the text prompt 1260. For example, guidance feature 1270 can be combined with the noisy feature 1235 using a cross-attention block within the reverse diffusion process 1240.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, enabling the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIG. 13.

A diffusion process may also be modified based on conditional guidance. In some cases, for example, a user provides a text prompt (e.g., text prompt 1260) describing content to be included in a generated image. In some examples, guidance can be provided in a form other than text, such as via an image, a sketch, a color, a style, or a layout. The system converts text prompt 1260 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 1200 generates an image based on the noise map and the conditional guidance vector.

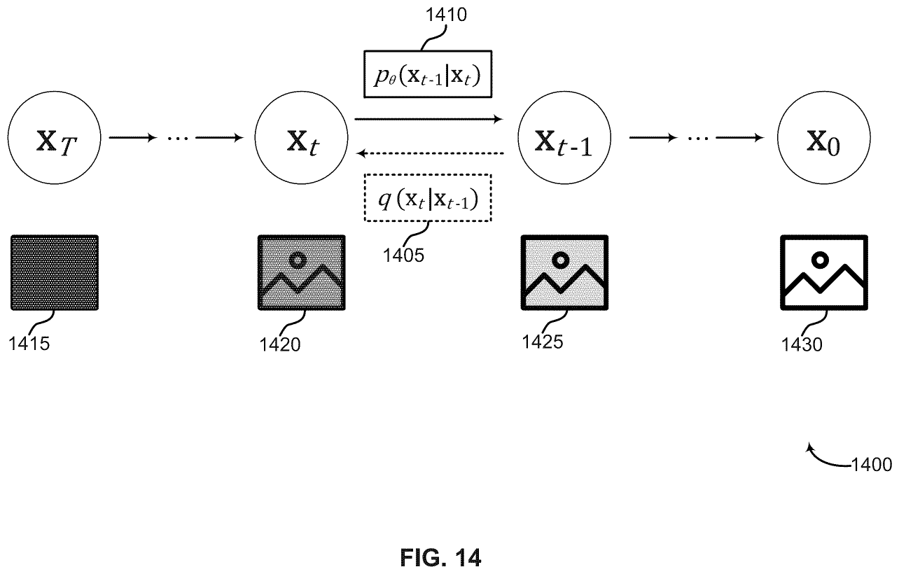

A diffusion process can include both a forward diffusion process 1230 for adding noise to an image (e.g., original image 1205) or features (e.g., original image feature 1220) in a latent space 1225 and a reverse diffusion process 1240 for denoising the images (or features) to obtain a denoised image (e.g., output image 1255). The forward diffusion process 1230 can be represented as q(xₜ|xₜ₋₁), and the reverse diffusion process 1240 can be represented as p_{θ}(xₜ₋₁|xₜ). Further detail on the diffusion process is described with reference to FIG. 14.

A diffusion model 1200 may be trained using both a forward diffusion process 1230 and a reverse diffusion process 1240. In one example, an untrained model is initialized. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 1230 in N stages. In some cases, the forward diffusion process 1230 is a fixed process where Gaussian noise is successively added to an image. In latent diffusion models, the Gaussian noise may be successively added to features (e.g., original image feature 1220) in a latent space 1225.

At each stage n, starting with stage N, a reverse diffusion process 1240 is used to predict the image or image features at stage n−1. For example, the reverse diffusion process 1240 can predict the noise that was added by the forward diffusion process 1230, and the predicted noise can be removed from the image to obtain the predicted image. In some cases, an original image 1205 is predicted at each stage of the training process.

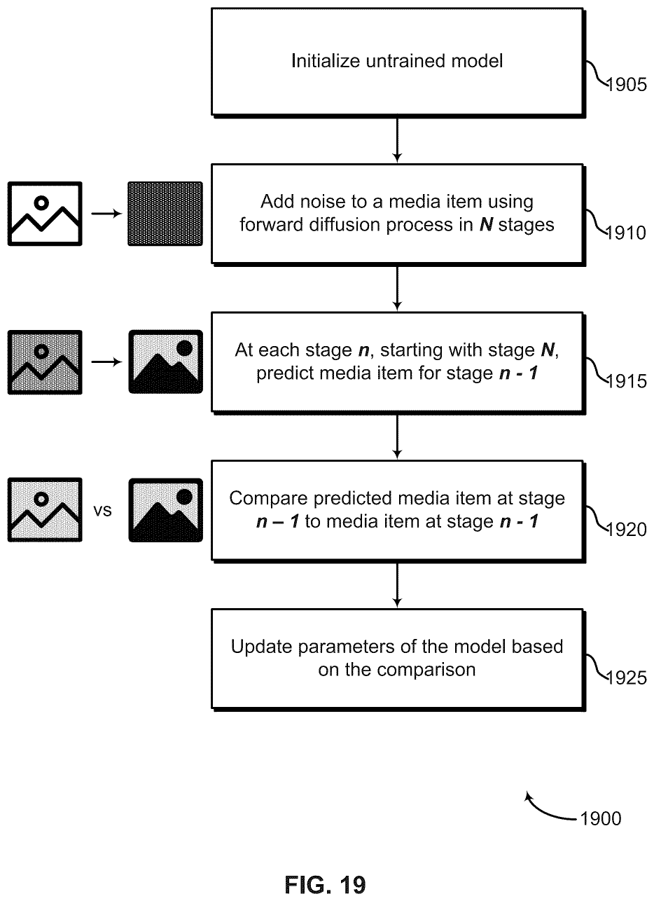

The training component (e.g., training component described with reference to FIG. 7) compares predicted image (or image features) at stage n−1 to an actual image (or image features), such as the image at stage n−1 or the original input image. For example, given observed data x, the diffusion model 1200 may be trained to minimize the variational upper bound of the negative log-likelihood −log p_{θ}(x) of the training data. The training component then updates parameters of the diffusion model 1200 based on the comparison. For example, parameters of a U-Net may be updated using gradient descent. Time-dependent parameters of the Gaussian transitions can also be learned. Further detail on training the diffusion model is described with reference to FIG. 19.

FIG. 13 shows an example of a U-Net 1300 according to aspects of the present disclosure. The example shown includes U-Net 1300, input feature 1305, initial neural network layer 1310, intermediate feature 1315, down-sampling layer 1320, down-sampled feature 1325, up-sampling process 1330, up-sampled feature 1335, skip connection 1340, final neural network layer 1345, and output feature 1350.

In some examples, U-Net 1300 is an example of the component that performs the reverse diffusion process 1240 of diffusion model 1200 described with reference to FIG. 12 and includes architectural elements of the image generation model 730 described with reference to FIG. 7. The U-Net 1300 depicted in FIG. 13 is an example of, or includes aspects of, the architecture used within the reverse diffusion process described with reference to FIG. 12.

In some examples, diffusion models are based on a neural network architecture known as a U-Net. The U-Net 1300 takes input feature 1305 having an initial resolution and an initial number of channels, and processes the input feature 1305 using an initial neural network layer 1310 (e.g., a convolutional network layer) to produce intermediate feature 1315. The intermediate feature 1315 is then down-sampled using a down-sampling layer 1320 such that the down-sampled feature 1325 has a resolution less than the initial resolution and a number of channels greater than the initial number of channels.

This process is repeated multiple times, and then the process is reversed. For example, the down-sampled feature 1325 is up-sampled using up-sampling process 1330 to obtain up-sampled feature 1335. The up-sampled feature 1335 can be combined with intermediate feature 1315 having the same resolution and number of channels via a skip connection 1340. These inputs are processed using a final neural network layer 1345 to produce output feature 1350. In some cases, the output feature 1350 has the same resolution as the initial resolution and the same number of channels as the initial number of channels.

In some cases, U-Net 1300 takes an additional input feature to produce conditionally generated output. For example, the additional input feature could include a vector representation of an input prompt. The additional input feature can be combined with the intermediate feature 1315 within the neural network at one or more layers. For example, a cross-attention module can be used to combine the additional input features and the intermediate feature 1315.

### Diffusion Process

FIG. 14 shows an example of a diffusion process 1400 according to aspects of the present disclosure. The example shown includes diffusion process 1400, forward diffusion process 1405, reverse diffusion process 1410, noisy image 1415, first intermediate image 1420, second intermediate image 1425, and original image 1430.

Diffusion process 1400 can include forward diffusion process 1405 for adding noise to original image 1430 (e.g., original image 1205 described with reference to FIG. 12) or features (e.g., original image feature 1220 described with reference to FIG. 12) in a latent space. In some aspects, diffusion process 1400 includes reverse diffusion process 1410 for denoising the noisy image 1415 (or image features) to obtain a denoised image (or original image 1430). The forward diffusion process 1405 can be represented as q(xₜ|xₜ₋₁), and the reverse diffusion process 1410 can be represented as p_{θ}(xₜ₋₁|xₜ). In some cases, the forward diffusion process 1405 is used during training to generate images with successively greater noise, and a neural network is trained to perform the reverse diffusion process 1410 (e.g., to successively remove the noise).

In an example forward diffusion process 1405 for a latent diffusion model (e.g., diffusion model 1200 described with reference to FIG. 12), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1410. During the reverse diffusion process 1410, the diffusion model begins with noisy data x_{T}, such as a noisy image 1415 and denoises the data to obtain the p_{θ}(xₜ₋₁| xₜ). At each step t−1, the reverse diffusion process 1410 takes xₜ, such as the first intermediate image 1420, and t as input. Here, t represents a step in the sequence of transitions associated with different noise levels, The reverse diffusion process 1410 outputs xₜ₋₁, such as the second intermediate image 1425, iteratively until x_{T} is reverted back to x₀, the original image 1430. The reverse diffusion process 1410 can be represented as:

$${p}_{θ} ( {x}_{t - 1} \vert {x}_{t} ) : \text{=} N ( {x}_{t - 1} ; {μ}_{θ} ( {x}_{t} , t ) , {\sum }_{θ} ( {x}_{t} , t ) ) . \qquad ( \# )$$

The joint probability of a sequence of samples in the Markov chain can be written as a product of conditionals and the marginal probability:

$${x}_{T} \text{:} {p}_{θ} ( {x}_{0 : T} ) : \text{=} p ( {x}_{T} ) {\prod }_{t = 1}^{T} {p}_{θ} ( {x}_{t - 1} \vert {x}_{t} ) , \qquad ( \# )$$

where p(x_{T})=N(x_{T};0,I) is the pure noise distribution as the reverse diffusion process 1410 takes the outcome of the forward diffusion process 1405, a sample of pure noise, as input and Π_{T=1}^{T}p_{θ}(xₜ₋₁|x_{T}) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

### Image Processing

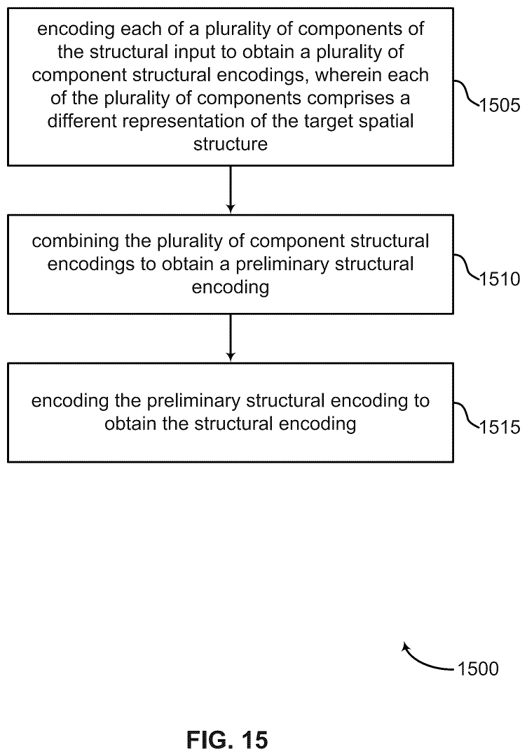

FIG. 15 shows an example of a method 1500 for generating a synthetic image using a structural encoder according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1505, the system encodes each of a set of components of the structural input to obtain a set of component structural encodings, where each of the set of components includes a different representation of the target spatial structure. In some cases, the operations of this step refer to, or may be performed by, a feature encoder as described with reference to FIG. 8. In some cases, the components of the structural input may be referred to as the feature maps described with reference to FIG. 8. For example, the features maps include a depth map, edge map, and/or entity map. In some cases, each of the feature maps represents a different target spatial structure of the input image.

At operation 1510, the system combines the set of component structural encodings to obtain a preliminary structural encoding. In some cases, the operations of this step refer to, or may be performed by, a condition encoder as described with reference to FIGS. 7 and 8. In some cases, for example, the preliminary structural encoding refers to the combined structural encoding as described with reference to FIG. 8. In some cases, the preliminary structural encoding includes the one or more of structural encoding and the noise input.

At operation 1515, the system encodes, using the condition encoder, the preliminary structural encoding to obtain the structural encoding. In some cases, the operations of this step refer to, or may be performed by, a condition encoder as described with reference to FIGS. 7 and 8. In some cases, the structural encoding may be referred to as the down-sampled encoding described with reference to FIG. 8. For example, the down-sampled encoding (or the structural encoding) is combined with the down-sampled feature generated by the image generation model to obtain the combined down-sampled encoding.

### Training and Evaluation

In FIGS. 16-19, a method, apparatus, non-transitory computer readable medium, and system for training a machine learning model include obtaining a training set comprising a training structural input indicating a spatial structure and a ground-truth image including the spatial structure, and training, using the training set, an image generation model to generate a synthetic image based on a structural input, where the synthetic image includes the spatial structure.

Some examples of the method, apparatus, non-transitory computer readable medium, and system further include jointly training a condition encoder together with the image generation model. In some aspects, the image generation model is trained using a training set including a training structural input indicating a spatial structural and a ground-truth image including the target spatial structure.

Some examples of the method, apparatus, non-transitory computer readable medium, and system further include generating a structural encoding based on the structural input. Some examples further include generating a predicted image based on the structural encoding. Some examples further include computing a loss function by comparing the predicted image with the ground-truth image. Some examples further include updating parameters of the image generation model based on the loss function

According to some aspects, a method, apparatus, non-transitory computer readable medium, and system for training a machine learning model are described. One or more aspects of the method, apparatus, non-transitory computer readable medium, and system include obtaining a training set comprising a training structure input and a ground truth image and training, using the training set, a machine learning model to generate a synthetic image based on a structure input.

FIG. 16 shows an example of a method 1600 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1605, the system obtains a training set including a training structural input indicating a spatial structure and a ground-truth image including the spatial structure. In some cases, the operations of this step refer to, or may be performed by, a training component as described with reference to FIG. 7. In some cases, the training set includes text-image pair data. For example, a training image is fed into a feature extractor to obtain the training structure input. In some cases, the training image (or the ground-truth image) includes elements of the spatial structure.

At operation 1610, the system trains, using the training set, an image generation model to generate a synthetic image based on a structural input, where the synthetic image includes the spatial structure. In some cases, the operations of this step refer to, or may be performed by, a training component as described with reference to FIG. 7. In some cases, the training component computes a diffusion loss based on the synthetic image and the ground-truth image, where the image generation model is updated based on the diffusion loss.

FIG. 17 shows an example of figure description according to aspects of the present disclosure. The example shown includes training system 1700, training image 1705, feature extractor 1710, feature map 1735, training structural input 1760, text prompt 1765, and image generation model 1770. In one aspect, feature extractor 1710 includes depth model 1715, edge detection model 1720, scribble model 1725, and entity segmentation model 1730. In one aspect, feature map 1735 includes depth map 1740, edge map 1745, scribble map 1750, and entity map 1755.

Referring to FIG. 17, training image 1705 is provided to feature extractor 1710 to generate feature map 1735. In some cases, for example, the feature extractor 1710 includes a depth model 1715, an edge detection model 1720, a scribble model 1725, and an entity segmentation model 1730. In some cases, the feature map 1735 includes a depth map 1740, an edge map 1745, a scribble map 1750, and an entity map 1755. In some cases, each of the feature map 1735 is generated based on the training image 1705 using a corresponding feature extractor 1710. For example, depth model 1715 generates depth map 1740 based on the training image 1705. For example, edge detection model 1720 generates edge map 1745 based on the training image 1705. For example, scribble model 1725 generates scribble map 1750 based on the training image 1705. For example, entity segmentation model 1730 generates entity map 1755 based on the training image 1705.

According to some embodiments, the image generation model 1770 is trained based on feature map 1735, the training structural input 1760, and the text prompt 1765. For example, the image generation model 1770 is trained using one or more feature maps 1735 (e.g., the depth map 1740, edge map 1745, scribble map 1750, or entity map 1755) and the text prompt 1765 to generate a synthetic image. In some cases, a loss may be calculated based on each of the feature maps 1735 and the training structural input 1760. In some cases, a diffusion loss is calculated based on the synthetic image and the training image 1705. In some cases, parameters of the image generation model 1770 are updated based on the loss, the diffusion loss, or a combination thereof.

Depth model 1715 is an example of, or includes aspects of, the corresponding element described with reference to FIG. 9. Entity segmentation model 1730 is an example of, or includes aspects of, the corresponding element described with reference to FIG. 10. Depth map 1740 is an example of, or includes aspects of, the corresponding element described with reference to FIGS. 3, 5, and 9.

Edge map 1745 is an example of, or includes aspects of, the corresponding element described with reference to FIGS. 4, 5, and 9. Entity map 1755 is an example of, or includes aspects of, the corresponding element described with reference to FIG. 10. Text prompt 1765 is an example of, or includes aspects of, the corresponding element described with reference to FIGS. 3-5, and 9-11. Image generation model 1770 is an example of, or includes aspects of, the corresponding element described with reference to FIGS. 7, and 9-11.

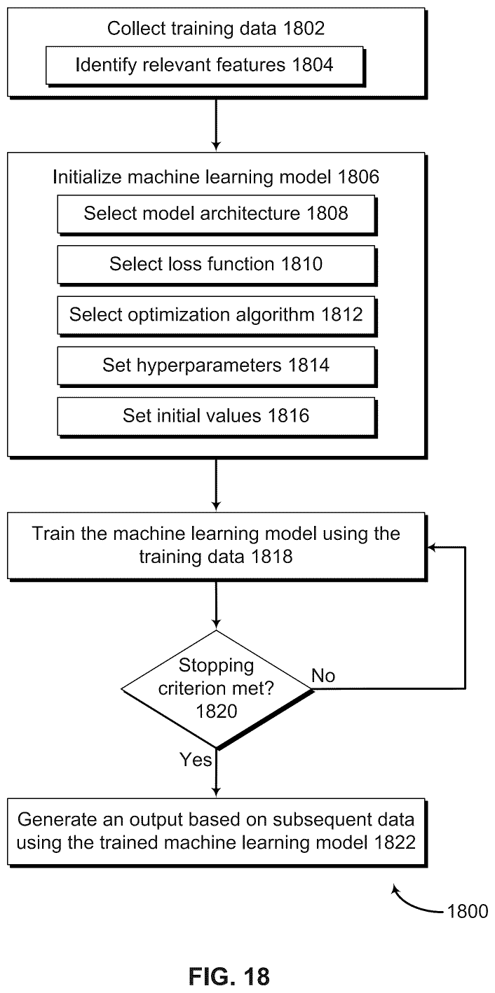

FIG. 18 shows an example of a flow diagram depicting an algorithm 1800 as a step-by-step procedure in an example implementation of operations performable for training a machine learning model according to aspects of the present disclosure. In some embodiments, the algorithm 1800 describes an operation of the training component 735 described for configuring the image generation model 730 and/or the condition encoder 725 as described with reference to FIG. 7. The algorithm 1800 provides one or more examples of generating training data, use of the training data to train a machine-learning model, and use of the trained machine-learning model to perform a task.

To begin in this example, a machine-learning system collects training data (block 1802) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1804) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1806). Initialization of the machine-learning model includes selecting a model architecture (block 1808) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1810). The loss function is utilized to measure a difference between an output of the machine-learning model (e.g., the model predictions) and target values (e.g., as expressed by the training data) to be used to train the machine-learning model. Additionally, an optimization algorithm is selected (block 1812) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1816) examples of which include initializing weights and biases of nodes to increase efficiency in training and computational resources consumption as part of training. Hyperparameters are also set (block 1814) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1818) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1820), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1820), algorithm 1800 continues the training of the machine-learning model using the training data (block 1818) in this example.

If the stopping criterion is met (“yes” from decision block 1820), the trained machine-learning model is then utilized to generate an output based on subsequent data (block 1822). The trained machine-learning model, for instance, is trained to perform a task as described above and therefore once trained is configured to perform that task based on subsequent data received as an input and processed by the machine-learning model.

FIG. 19 shows an example of a method 1900 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In some embodiments, the method 1900 describes an operation of the training component 735 described for training the image generation model 730 as described with reference to FIG. 7. The method 1900 represents an example for training a reverse diffusion process as described above with reference to FIG. 14. In some examples, these operations are performed by a system including a processor executing a set of codes to control functional elements of an apparatus, such as the image generation model described in FIG. 7.

At operation 1905, the system initializes an untrained model. In some cases, the operations of this step refer to, or may be performed by, a training component as described with reference to FIG. 7. Initialization can include defining the architecture of the model and establishing initial values for the model parameters. In some cases, the initialization can include defining hyper-parameters such as the number of layers, the resolution and channels of each layer block, the location of skip connections, and the like.

At operation 1910, the system adds noise to media item using forward diffusion process in N stages. In some cases, the operations of this step refer to, or may be performed by, a training component as described with reference to FIG. 7. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1915, the system at each stage n, starting with stage N, predict media item for stage n−1. In some cases, the operations of this step refer to, or may be performed by, a training component as described with reference to FIG. 7. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1920, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 7. For example, given observed data x, the diffusion model may be trained to minimize the variational upper bound of the negative log-likelihood −log p_{θ}(x) of the training data.

At operation 1925, the system updates parameters of the model based on the comparison. In some cases, the operations of this step refer to, or may be performed by, a training component as described with reference to FIG. 7. For example, parameters of a U-Net may be updated using gradient descent. Time-dependent parameters of the Gaussian transitions can also be learned.

### Computing Device

FIG. 20 shows an example of a computing device 2000 according to aspects of the present disclosure. The example shown includes computing device 2000, processor 2005, memory subsystem 2010, communication interface 2015, I/O interface 2020, user interface component 2025, and channel 2030.

In some embodiments, computing device 2000 is an example of, or includes aspects of, the image processing apparatus described with reference to FIGS. 1 and 7. In some embodiments, computing device 2000 includes processor 2005 that can execute instructions stored in memory subsystem 2010 to obtain a structural input indicating a target spatial structure, encode the structural input to obtain a structural encoding representing the target spatial structure, and generate a synthetic image based on the structural encoding.

According to some embodiments, processor 2005 includes one or more processors. In some cases, processor 2005 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 2005 is configured to operate a memory array using a memory controller.

In other cases, a memory controller is integrated into processor 2005. In some cases, processor 2005 is configured to execute computer-readable instructions stored in a memory to perform various functions. In some embodiments, processor 2005 includes special-purpose components for modem processing, baseband processing, digital signal processing, or transmission processing. Processor 2005 is an example of, or includes aspects of, the processor unit described with reference to FIG. 7.

According to some embodiments, memory subsystem 2010 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 2010 is an example of, or includes aspects of, the memory unit described with reference to FIG. 7.

According to some embodiments, communication interface 2015 operates at a boundary between communicating entities (such as computing device 2000, one or more user devices, a cloud, and one or more databases) and channel 2030 and can record and process communications. In some cases, communication interface 2015 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 2015.

According to some embodiments, I/O interface 2020 is controlled by an I/O controller to manage input and output signals for computing device 2000. In some cases, I/O interface 2020 manages peripherals not integrated into computing device 2000. In some cases, I/O interface 2020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2020 or hardware components controlled by the I/O controller. I/O interface 2020 is an example of, or includes aspects of, the I/O module described with reference to FIG. 7.

According to some embodiments, user interface component 2025 enables a user to interact with computing device 2000. In some cases, user interface component 2025 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation systems). Example experiments demonstrate that the image processing apparatus based on the present disclosure outperforms conventional image generation systems. Details on the example use cases based on embodiments of the present disclosure are described with reference to FIGS. 3-5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a structural input indicating a target spatial structure;
encoding, using a condition encoder, the structural input to obtain a structural encoding representing the target spatial structure; and
generating, using an image generation model, a synthetic image based on the structural encoding, wherein the synthetic image depicts an object having the target spatial structure.

2. The method of claim 1, wherein encoding the structural input comprises:
encoding each of a plurality of components of the structural input to obtain a plurality of component structural encodings, wherein each of the plurality of components comprises a different representation of the target spatial structure;
combining the plurality of component structural encodings to obtain a preliminary structural encoding; and
encoding, using the condition encoder, the preliminary structural encoding to obtain the structural encoding.

3. The method of claim 2, wherein:
each of the plurality of component structural encodings is generated by a different structural encoder.

4. The method of claim 2, wherein:
each of the plurality of component structural encodings has a different number of channels.

5. The method of claim 2, wherein:
the plurality of component structural encodings includes a depth encoding, an edge encoding and an entity encoding.

6. The method of claim 1, further comprising:
providing the structural encoding to a first layer of the image generation model;
downsampling the structural encoding to obtain a downsampled structural encoding; and
providing the downsampled structural encoding to a second layer of the image generation model.

7. The method of claim 1, wherein generating the synthetic image comprises:
obtaining a noise input; and
denoising the noise input based on the structural encoding.

8. The method of claim 1, further comprising:
performing a multiple convolution process on the structural encoding.

9. The method of claim 1, further comprising:
obtaining a structural adherence parameter, wherein the synthetic image is generated using the structural encoding based on the structural adherence parameter.

10. The method of claim 1, further comprising:
obtaining a text prompt describing the object, wherein the synthetic image is generated based on the text prompt.

11. The method of claim 1, further comprising:
obtaining a style prompt indicating a style element, wherein the synthetic image is generated based on the style prompt to include the style element.

12. The method of claim 1, wherein obtaining the structural input comprises:
obtaining a preliminary image; and
generating the structural input based on the preliminary image.

13. The method of claim 1, wherein:
the image generation model is trained using a training set including a training structural input indicating a spatial structural and a ground-truth image including the target spatial structure.

14. A method of training a machine learning model, the method comprising:
obtaining a training set comprising a training structural input indicating a spatial structure and a ground-truth image including the spatial structure; and
training, using the training set, an image generation model to generate a synthetic image based on a structural input, wherein the synthetic image includes the spatial structure.

15. The method of claim 14, wherein training the machine learning model comprises:
jointly training a condition encoder together with the image generation model.

16. The method of claim 14, wherein training the image generation model comprises:
generating a structural encoding based on the structural input;
generating a predicted image based on the structural encoding;
computing a loss function by comparing the predicted image with the ground-truth image; and
updating parameters of the image generation model based on the loss function.

17. A system comprising:
a memory component;
a processing device coupled to the memory component, the processing device configured to perform operations comprising:
obtaining a structural input indicating a target spatial structure;
encoding, using a condition encoder, the structural input to obtain a structural encoding representing the target spatial structure; and
generating, using an image generation model, a synthetic image based on the structural encoding, wherein the synthetic image depicts an object having the target spatial structure.

18. The system of claim 17, wherein:
the condition encoder comprises a plurality of convolutional layers and a plurality of activation layers.

19. The system of claim 17, wherein:
the image generation model comprises more parameters than the condition encoder.

20. The system of claim 17, further comprising:
a text encoder configured to encode a text prompt to obtain a text embedding.
